(19) United States
(12) Patent Application Publication
(10) Pub. No.: US 2020/0123382 A1
(43) Pub. Date: Apr. 23, 2020

(54) POLYMER COMPOSITIONS FOR FLAME RETARDANCY AND/OR IMPROVED MELT DRIPPING PROPERTIES

(71) Applicant: QED Labs Inc., Waltham, MA (US)

(72) Inventors: Gangadhar JOGIKALMATH, Chestnut Hill, MA (US); Adam VISENTIN, Cambridge, MA (US); Deepak Arabagatte RAMAPPA, Somerville, MA (US)

(21) Appl. No.: 16/095,857

(22) PCT Filed: Apr. 24, 2017
(86) PCT No.: PCT/US2017/029168

§ 371 Date: Oct. 23, 2018

Related U.S. Application Data
(60) Provisional application No. 62/326,820, filed on Apr. 24, 2016.

(51) Int. Cl. C08L 77/02; D01F 1/07; D01F 8/12; C08K 5/23

(52) U.S. Cl. CPC C08L 77/02; D01F 1/07; D01F 8/12; C08L 2203/12; C08L 2201/02; C08L 2312/00; C08K 5/23

(57) ABSTRACT

Compositions with improved flame properties and with improved melt dripping properties can include a first polymer and a reactive component. The first polymer may be nylon or polyethylene terephthalate (PET). The composition can be formed into fibers and woven into a fabric. Crosslinking of the first polymer or of the first polymer and the reactive component can provide the improved properties.

### CROSS-REFERENCE TO RELATED APPLICATIONS

This application claims priority to the provisional patent application filed Apr. 24, 2016 and assigned U.S. App. No. 62/326,820, the disclosure of which is hereby incorporated by reference.

### FIELD OF THE DISCLOSURE

The present disclosure relates to compositions, and methods providing flame and fire protection, including fabrics with improved melt dripping properties.

### BACKGROUND OF THE DISCLOSURE

Flame retardancy and voidance of melt dripping are two important properties in articles such as fabrics. Flame retardants are chemicals that resist the spread of fire and are used in, for example, thermoplastics, textiles, and coatings. Typically, flame retardants are halogenated (e.g., brominated) or phosphate based. However, these flame retardant and fire protection materials are generally inefficient or have negative impacts on the environment. For example, halogenated flame retardants, such as brominated flame retardants, are persistent, bio-accumulative, and toxic to both humans and the environment. Brominated flame retardants are suspected of causing negative neurobehavioral effects and endocrine disruption. Brominated flame retardants also release toxic gases which can cause more deaths than fire itself.

Non-halogenated flame retardants, such as phosphate based flame retardants, are generally non-toxic and environmentally friendly. However, non-halogenated flame retardant additives currently used in the market are less efficient than halogenated flame retardants. Generally, these phosphate based flame retardants require high loading (i.e., doses/volumes) which reduces efficacy. Such high doses may compromise the mechanical properties, thereby increasing susceptibility to failure of injection molded parts and other materials to which the phosphate based flame retardants are applied. Phosphate flame retardants also tend to leach out of the materials to the surface rendering the material vulnerable to fire.

Non-halogenated flame retardant additives currently used in the market are less efficient than halogenated flame retardants. For example, polymers may contain between 30% and 60% of phosphorus based flame retardant substances where only 15% of halogenated flame retardants may be sufficient. This higher percentage can compromise the structural integrity of the article and cause the properties of the final product to deteriorate.

Melt dripping of plastics or fabrics when exposed to flame or fire is also undesirable. Melt drips on the skin of a wearer can cause grievous bodily injury because a hot, sticky, melted substance formed from the plastic or fabric can cause localized and extremely severe burns. For example, the polyamide (such as nylon-6 and nylon-6,6) uniforms for defense personnel show undesirable melt dripping problems when exposed to flame.

Therefore, it is desirable to have fibers, fabrics, and other articles that show improved flame retardancy and that are capable of lowered melt dripping when exposed to flame.

### BRIEF SUMMARY OF THE DISCLOSURE

The above objects are met by the compositions, articles, and methods disclosed herein.

In a first embodiment, a composition is provided. The composition includes a plurality of first resins that include a first polymer and a reactive component. The reactive component is present at 0.1% to 10% by weight of the polymer. The first polymer or the first polymer and the reactive component are configured to crosslink upon exposure to flame. The first polymer or the first polymer and the reactive component are configured to not react at a melting temperature of the first polymer. The first polymer may be nylon, polyethylene terephthalate (PET), or other materials.

The first polymers may include at least one reactive end group selected from the group consisting of an amine, a carboxyl, and a hydroxyl.

In an instance, the first polymer is nylon and the reactive component includes a functional group selected from the group consisting of an epoxy, an anhydride, an amine, an isocyanate, and a hydroxyl.

Chain ends of the first polymer may be modified by the reactive component such that the chain ends are configured to react with each other upon exposure to a temperature above the melting temperature of the first polymer.

The first polymer can include at least one functional group that is blocked or passivated such that the first polymer is rendered inert to reaction with crosslinking molecules until exposure to a temperature above the melting temperature of the first polymer. The reactive component may be a monofunctional molecule having functional groups complementary to end groups of the first polymer. A reaction between the reactive component and the first polymer may form a covalent linkage.

The reactive component may be a crosslinking molecule. The first polymer can be rendered inert to reaction with crosslinking molecules until the exposure to flame. The first polymer can be configured to split into fragments with reactive ends upon the exposure to flame such that the reactive ends react with the reactive component to form a network interpenetrating polymer that enhances molecular weight and viscosity.

The crosslinking can be configured to provide chain scission. The chain scission can create fragments with reactive end groups. The reactive end groups may be selected from the group consisting of caprolactone and caprolactam or from the group consisting of amine and carboxyl.

The first polymer can include a first functional group and the reactive component can include a second functional group. The first functional group and the second functional group may be selected from the following functional group combinations: amine and acids, amine and epoxide, amine and anhydride, amine and isocyanate, amine and aldehyde, amine and alkyl halide, amine and alkyl sulfonate, amine and thiol, epoxide and anhydride, epoxide and hydroxyl, and epoxide and acid.

The reactive component can include a nitrogen double bond. The reactive component may be an azo compound. The reactive component can be configured to homopolymerize upon the exposure to flame thereby increasing crosslinking of the first polymer. The reactive component also can be configured to react with multiple end groups of the first polymer upon the exposure to flame.

The first polymer and reactive component can be formed as a first fiber. A second fiber can be formed with the first fiber as a bicomponent fiber. The reactive component in the first fiber can be configured to react with a functional group of the second fiber to form a crosslink where melt fronts meet.

The reactive component and the first polymer can be configured to not react upon the exposure to flame. The first polymer can be configured to only crosslink with itself upon the exposure to flame thereby forming a network interpenetrating polymer that enhances molecular weight and viscosity.

A fabric can be formed from any of the preceding compositions. The fabric may further include a fiber selected from the group consisting of cotton, rayon, wool, hair, silk, and aramid. The fabric may further include metallic fibers. The fabric may further include a flame retardant that includes a phosphorus compound.

A method is provided in a second embodiment. The method comprises providing a plurality of first resins that include a first polymer; providing a reactive component; and mixing the first polymer and the reactive component to form a composition. The reactive component is present at 0.1% to 10% by weight of the polymer. The first polymer or the first polymer and the reactive component are configured to crosslink upon exposure to flame. The first polymer or the first polymer and the reactive component are configured to not react at a melting temperature of the first polymer. The first polymer may be nylon, polyethylene terephthalate (PET), or other materials.

The method can further include forming fibers from the composition and weaving the fibers to form a fabric.

In an instance, the reactive component is a crosslinker. The first polymer is rendered inert to reaction with crosslinking molecules until the exposure to flame. The reactive component is an interstitial additive.

The first polymer may be passivated prior to exposure to the reactive component. The mixing may occur after passivation during extrusion.

A method is provided in a third embodiment. The method comprises providing a composition that includes a plurality of first resins that include a first polymer and a reactive component; exposing the composition to flame; and forming a network interpenetrating polymer that enhances molecular weight and viscosity thereby reducing melt dripping. The reactive component is present at 0.1% to 10% by weight of the polymer. The reactive component and the first polymer are configured to not react upon the exposure to flame. The first polymer is configured to only crosslink with itself upon the exposure to flame.

### DESCRIPTION OF THE DRAWINGS

For a fuller understanding of the nature and objects of the disclosure, reference should be made to the following detailed description taken in conjunction with the accompanying drawings, in which:

FIG. 1 is a flowchart in accordance with an embodiment of the present disclosure.

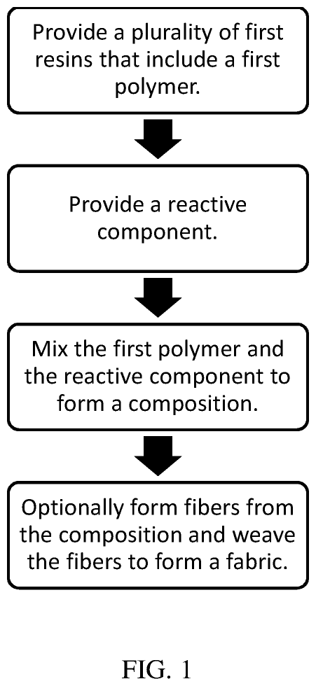

### DETAILED DESCRIPTION OF THE DISCLOSURE

The present disclosure may be understood more readily by reference to the following description taken in connection with the accompanying figures and examples, all of which form a part of this disclosure. It is to be understood that this disclosure is not limited to the specific products, methods, conditions, or parameters described and/or shown herein, and that the terminology used herein is for the purpose of describing particular embodiments by way of example only and is not intended to be limiting of any claim. Similarly, unless specifically otherwise stated, any description as to a possible mechanism or mode of action or reason for improvement is meant to be illustrative only, and the disclosure herein is not to be constrained by the correctness or incorrectness of any such suggested mechanism or mode of action or reason for improvement. Throughout this text, it is recognized that the descriptions refer to compositions and methods of making and using the compositions. That is, where the disclosure describes and/or claims a feature or embodiment associated with a composition or apparatus or a method of making or using a composition or apparatus, it is appreciated that such a description and/or claim is intended to extend these features or embodiment to embodiments in each of these contexts (i.e., composition, apparatus, and methods of using).

In the present disclosure the singular forms “a,” “an,” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

When a value is expressed as an approximation by use of the descriptor “about,” it will be understood that the particular value forms another embodiment. In general, use of the term “about” indicates approximations that can vary depending on the desired properties sought to be obtained by the disclosed subject matter and is to be interpreted in the specific context in which it is used, based on its function. The person skilled in the art will be able to interpret this as a matter of routine. In some cases, the number of significant figures used for a particular value may be one non-limiting method of determining the extent of the word “about.” In other cases, the gradations used in a series of values may be used to determine the intended range available to the term “about” for each value. Where present, all ranges are inclusive and combinable. That is, references to values stated in ranges include every value within that range.

In general, when a range is presented, all combinations of that range are disclosed. For example, 1 to 4 includes not only 1 to 4 but also 1 to 2, 1 to 3, 2 to 3, 2 to 4, and 3 to 4.

It is to be appreciated that certain features of the disclosure which are, for clarity, described herein in the context of separate embodiments, may also be provided in combination in a single embodiment. That is, unless obviously incompatible or specifically excluded, each individual embodiment is deemed to be combinable with any other embodiment(s) and such a combination is considered to be another embodiment. Conversely, various features of the disclosure that are, for brevity, described in the context of a single embodiment, may also be provided separately or in any sub-combination. Finally, while an embodiment may be described as part of a series of steps or part of a more general structure, each said step may also be considered an independent embodiment in itself, combinable with others.

When a list is presented, unless stated otherwise, it is to be understood that each individual element of that list, and every combination of that list, is a separate embodiment. For example, a list of embodiments presented as “A, B, or C” is to be interpreted as including the embodiments, “A,” “B,” “C,” “A or B,” “A or C,” “B or C,” or “A, B, or C.”

Melt dripping and flammability of articles such as fabrics when exposed to flame can be problematic. For example, fabrics made of polyethylene terephthalate (PET) and nylon can melt drip when aflame and cause grievous injuries to people wearing them. Though flame retardant systems are used in PET and in nylon, none of them have been able to successfully reduce or stop melt dripping. The embodiments described herein can be used to reduce or eliminate melt drips when fabrics or articles made of PET, nylon, or other polymeric materials encounter flame. It is expected that compositions with crosslinking occurring when exposed to flame will resist dripping (due to high viscosity) and have a high tendency to form char.

In one embodiment, crosslinking of a reactive component added to the fiber spinning melt is encouraged to form an interpenetrating network with the nylon or other polymer matrix. The cross-linking enhances the viscosity of the material when aflame, potentially reducing the melt drips. The crosslinking may occur in the polymer or may occur between the reactive component and the polymer. An interpenetrating network can be two crosslinked polymer networks physically intertwined with each other without actually having chemical connections between the two.

In a composition with the polymer, the reactive components may be in a range from 0.1% to 10% by weight of the polymer, including all values to the 0.1% and ranges between. For example, the reactive components is in a range from 0.1% to 2.0%, 0.1% to 1.5%, 0.1% to 1.0%, or 0.1% to 0.5% by weight of the polymer.

While the first polymer or the first polymer and the reactive component can crosslink upon exposure to flame, the first polymer or the first polymer and the reactive component may not react at a melting temperature of the first polymer. For example, the first polymer or the first polymer and the reactive component may not crosslink at the melting temperature of the first polymer. The degree of such crosslinking at the melting temperature may be 0%, less than 0.5%, less than 1%, less than 2%, less than 5%, or less than 10%.

If the polymer such as nylon or PET is crosslinked prior to melt spinning or during melt spinning, the resulting increase in viscosity affects how fibers are made and their eventual mechanical properties by reducing the drawability and reducing the ability to draw very fine thin fibers. The crosslinking of the polymers such as nylon and PET therefore should happen in the fiber when it is exposed to flame. Such a system will enable the high throughput production of fine fibers with excellent mechanical properties.

Many condensation polymers, such as nylon, PET, or polycarbonate (PC), have reactive end groups such as amine, carboxyl, hydroxyl, or other end groups. These functional groups can be crosslinked between neighboring polymers to form a network that resists flammability.

Such crosslinking can be configured to happen after production of fibers and/or during exposure to flame. Many polymers have a melting temperature at a value from approximately 120° C. to 300° C., though other values are possible. Flame exposure can involve a temperature from approximately 400° C. to 800° C.

In an embodiment, the polymer chain ends can be modified by the use of reactive components that react with each other at very high temperatures above the melting temperature of the polymer, such as temperatures that are encountered during exposure to flame. This enables production of fibers at melting temperatures of the polymers without occurrence of crosslinking during such processing. The reactive component are reactively coupled to the chain ends. These functional molecules contain, for example, a triple bond which activates at temperatures above 300° C. which is higher than the melting temperature of most polymers. When exposed to flame, the reaction can occurs at a temperature above 350° C. The crosslinking occurs and forms a flame resistant composition. Examples include 4-(phenylethynyl) phthalic anhydride. Other triple bond containing aldehydes, epoxy, and amine functional molecules may be used.

In another embodiment, the functional groups of the polymers can be blocked or passivated by the use of monofunctional small molecules such that the polymers are rendered inert to reaction with crosslinking molecules until exposure to flame. Such monofunctional molecules called passivators, which are examples of reactive components, can have complementary functional groups to that of end groups of polymer chains to be modified such that the reaction between such groups may result in a covalent linkage. These reactive components may be interstitial additives until exposure to flame. Upon exposure to flame, the polymer breaks down and splits into fragments with reactive ends (e.g., non-passivated ends) that react with the reactive component to form a network interpenetrating polymer that enhances molecular weight and viscosity. In another embodiment such complementary functional groups may interact ionically or via van der waals forces or via pi-pi stacking of aromatic groups. For example, nylon has amine and acid groups at its chain ends. Any monofunctional molecule that can react with either amine or acid group can render nylon inert or “passivate” it. Examples include monofunctional epoxy, monofunctional anhydride, monofunctional acid chloride molecules, or other materials. Examples of epoxy based passivators include C₈-C₁₀-glycidyl ether, cresyl glycidyl ether, nonyl phenyl glycidyl ether, phenyl glycidyl ether, pentaerythritol glycidyl ether, and sorbitol glycidyl ether. Anhydride based passivators include anhydrides of polyolefins such as maleated polypropylene, maleated waxes, maleic anhydride, benzoic anhydride, or succinic anhydride. Depending on the chain end functional group, an appropriate passivator may be chosen based on the following pairs: amine and acids, amine and epoxide, amine and anhydride, amine and isocyanate, amine and aldehyde, amine and alkyl halide, amine and alkyl sulfonate, amine and thiol, epoxide and anhydride, epoxide and hydroxyl, or epoxide and acid.

In another embodiment, the crosslinker is chosen such that it is stable and reactive during exposure to flame. When exposed to flame most condensation polymers undergo chain scission, including those that are end capped (or passivated) with reactive molecules (passivators). Such chain scission then opens up fresh functional groups able to react with the temperature stable crosslinker. Such reactions would then result in a densely crosslinked network which forms a stable front against flame propagation and may exhibit self-extinguishing properties. In an example, a nylon molecule is passivated as discussed above. The nylon, when mixed with a crosslinker that can react and crosslink nylon, does not react with nylon due to the nylon being inert (passivated). But when such composition is exposed to high temperature (e.g., a flame), the nylon starts disintegrating and exposes acid and amine groups. For instance, every time a nylon molecule is broken, two chain ends which have acid and amine groups may be formed. The acid and amine groups can then react with the crosslinker that has stayed stable throughout the exposure to flame because it is a stable molecule.

In an embodiment, nylon molecules with end groups such as amine and carboxyl can be passivated by the use of monofunctional epoxy or anhydride functionalized molecules (passivator) such as ERISYS GE-7 available by CVC Chemicals, which is the monoglycidyl ether of a naturally occurring C8-C10 aliphatic alcohol. A proper molar addition of the passivator molecule renders the amines and or the carboxyl end groups of the nylon unreactive by covalently bonding to nylon. Such passivated nylon could then be used in conjunction with other reactive molecules to create flame retardant polymers.

In an embodiment, an epoxy functional crosslinker with more than one epoxy group is added as a reactive component to the passivated nylon melt during fiber spinning. An epoxy crosslinker such as diglycidyl ether of polyethyleneoxide can be used to crosslink the nylon molecules. In another embodiment, epoxy modified 9,10-dihydro-9-oxy-10-phosphaphenanthrene-10-oxide (DOPO) flame retardant molecules from Struktol can be used as a crosslinker. In another embodiment, a benzoic dianhydride such as benzophenone-3,3′,4,4′-tetracarboxylic dianhydride molecule can be added to the passivated nylon melt and made into fibers. When such passivated nylon fibers containing active crosslinker molecules are exposed to flame, the resulting chain scission of the nylon at these high temperatures creates fragments that have reactive end groups caprolactone and/or caprolactam. These fragments then react with the bifunctional or multifunctional crosslinkers to create a crosslinked network that may help in preventing flame propagation and enhance char formation.

In another embodiment, an epoxy functional crosslinker with more than one epoxy group is added as a reactive component during a polymer processing step wherein polymer (e.g., nylon) is being processed with a passivator molecule first. For example, in extrusion of nylon polymer, it is mixed with a passivating molecule in the feed section first and upon melting and reaction between the passivator and nylon, in a separate downstream feedport of the extruder, a crosslinker described above is introduced. Since the nylon molecules are already rendered inert towards the crosslinker, no reaction takes place between the crosslinker and the passivated polymer. Now the crosslinker and the passivated nylon polymer are melt mixed to yield a homogeneous composition without the reaction taking place between them.

Besides caprolactone and/or caprolactam, the chain scission also can create fragments with amine and/or carboxyl reactive end groups.

In another embodiment a pentaerythritol modified with epoxy groups (such as ERISYS GE40 available by CVC Chemicals, which is epoxidized pentaerythritol) can be used as a crosslinker with passivated nylon. The presence of carbohydrate functionality in pentaerythritol enhances char formation. Thus, an ERISYS GE 40 molecule will not only crosslink the nylon fragments but also enhance char formation that may help in preventing flame propagation and enhance char formation.

The embodiments disclosed herein are not limited to nylons but can also be applied to other thermoplastic fibers such as PET by selecting appropriate reactive molecules. With nylon polymers that contain COOH and NH₂ functionalities, multifunctional crosslinkers (that may contain at least two functional groups) that may contain epoxy, anhydride, amine, isocyanate, or hydroxyl can be used to create crosslinked networks. Other groups or species also may be contained in the crosslinker and the crosslinkers are not limited merely to those examples herein.

In another embodiment, crosslinking can be induced between merging melt fronts, such as those encountered in bicomponent fibers. These fibers are made by mixing two dissimilar materials or similar materials which contain different additives in the spinneret head to create fibers with two different materials joined together in many different shapes. This technique can be exploited to create cross-linked fibers. In one example, two streams of nylon polymer melts, one containing a regular commercial nylon resin and the other containing a passivated nylon with a bifunctional crosslinker additive such as diglycidyl ether of PEG, are brought together to form a bicomponent fiber. When the melt fronts meet, the bifunctional crosslinker present in the passivated nylon front (with which it is incapable of reacting on account of passivation step rendering the nylon inert) reacts with the amine groups of the nylon melt front that is not passivated, forming crosslinks where the melt fronts meet resulting in enhanced resistance to melt dripping in the case of a fire.

The techniques and embodiments discussed here are not only applicable to melts but also to solvent phase processes such as fiber spinning from a “dope” (polymer solution), membrane, and hollow fiber production from polymer precipitation or other processes.

Melt dripping in articles such as fabrics can be reduced or eliminated by creating a high molecular weight polymer via a crosslinking mechanism during exposure to flame. This high molecular weight polymeric structure can have low melt viscosities and, hence, a lowered chance of dripping molten drops of polymer when exposed to flame. The fibers and fabrics could further be modified with flame retardants so that they show self-extinguishing behavior when exposed to flame.

The unfunctionalized polymers may have a molecular weight from about 2,000 Da to about 200,000 Da, including all values and ranges between. Upon exposure to flame, the molecular weight of the cross-linked system may be from about 50,000 Da to about 2,000,000 Da, including all values and ranges between. However, a cross-linked system may be considered as having an infinite molecular weight instead of a finite molecular weight. When crosslinks form and if it encompasses all the molecules in the mixture, one molecule is potentially formed. Usually, this crosslinking never proceeds to completion and a mix of very high molecular weight polymers are formed by crosslinking.

In an example, the cross-linked system has a melt viscosity from about 50 cps to about 20,000 cps, including all values to the 1 cps and ranges between. Viscosity increases with molecular weight. If all the polymer chains are connected via crosslinking, then the material will cease to be a thermoplastic that is capable of melting. Instead, the material turns into a thermoset that will char on exposure to flame instead of melting.

Embodiments disclosed herein can apply to synthetic resins and polymers such as nylons (polyamides), polyesters (both biodegradable and non-biodegradable), polyolefins (e.g., polypropylene, polyethylene), or styrene-based polymers (such as polystyrene and its copolymers). Embodiments disclosed herein also can apply to elastomeric fibers, such as those from natural rubbers (e.g., polyisoprene) or synthetic rubbers (e.g., polyurethanes, polybutadiene, styrene-butadiene rubbers). Embodiments disclosed herein also can apply to natural materials such as those from animals such as silk, wool, or animal hair. Embodiments disclosed herein also can apply to aromatic materials (such as an aramid like KEVLAR or NOMEX manufactured by DuPont), or polyurethane fibers (such as LYCRA spandex which is marketed by Invista). Embodiments disclosed herein also can apply to biodegradable materials such as polylactic acid (PLA), materials derived from proteins, or materials that are of plant origin and blends with synthetic resins. Embodiments disclosed herein can apply to other resins and polymers not specifically listed.

Crosslinking can be induced during fiber production by mixing two polymers containing complementary functional groups capable of reacting with each other. Crosslinking also can occur when the produced polymer articles/fabrics are exposed to flame. The crosslinking can be initiated at temperatures as low as about 120° C. when polyolefins are involved or as up to approximately about 350° C. to about 400° C. when high temperature polymers are involved. Temperatures ranges to initiate crosslinking can be between about 110° C. to about 450° C., including all values and ranges between, such as from about 150° C. to about 350° C.

A catalyst may be used to accelerate the reaction between complementary functional groups. In one such example, a fiber may contain excess of anhydride groups in one resin and epoxy groups in the other resin with an accelerator, such as an imidazole like IMICURE manufactured by Air Products and Chemicals, Inc. Other catalysts are possible.

Complementary functional groups include, but are not limited to, amine and acid, amine and epoxide, amine and anhydride, amine and isocyanate, amine and aldehyde, amine and alkyl halide, amine and alkyl sulfonate, amine and thiol, epoxide and anhydride, epoxide and hydroxyl, epoxide and acid, or other combinations that affect melt dripping.

In an embodiment, a fabric is constructed using an alternate pattern of two different fibers. One has a passivated polymer additive with functional group A (such as epoxy groups) and the other has a polymer that has not been passivated and contains functional groups B (such as amines) that are at the chain ends or separately contains additive with a functional group B (such as amines) on the surface (via grafting or topical treatment) or in the bulk (added during melt blending and processing). The surface predominantly refers to the polymer-air interface, whereas the bulk predominantly refers to the interior of the fiber. Distribution in the bulk or on the surface can be uniform or non-uniform. When such a fabric or other article is exposed to flame, the functional groups A and B react with each other in the heat elevating the molecular weight of the polymer network in the fiber immediately. This increased molecular weight will, in turn, increase viscosity thereby reducing melt drip.

Some of the functional groups are expected to be present at the surface of the fibers to enhance the melt viscosity at the interfaces of the melt fronts. As a flame event results in sudden elevation of temperatures, the fibers are expected be in a melt state almost instantaneously. This can result in melting and comingling of the different polymer fibers resulting in facile reaction between the functional groups in individual fibers and leading to increased melt viscosity. Thus, the depth at which the functional groups are located in a fiber can affect melt dripping properties. This depth can be adjusted to affect melt dripping properties.

For a completely cross-linked system, the ratio of the functional groups A and B may be about 1:1. However, the ratio can be chosen such that more than about 10% of the A groups can react with B groups resulting in an increased molecular weight. In an example, about 20% to about 80% of the A groups reacted with corresponding B groups resulting in increased melt viscosity. Note that a completely cross-linked system in this instance refers to about 100%, but only rarely will the cross-linked system proceed to 100%.

In another embodiment, a fiber of the same material or a different material can be cowoven to produce a flame retardant fiber. In an example, a PET fiber, which is carrying an additive such as a multifunctional epoxy compound, can be co-woven with a nylon fiber carrying either a multi-functional amine additive (such as a polyamine) or a polyhydroxy compound with a suitable catalyst, melt-blended into the nylon fiber. The nylon may or may not be passivated by pre-reacting with monofunctional molecules. When such fibers come together (e.g., are bonded, bound, melted, contacted, etc.) and are exposed to flame/heat, they melt and fuse and the complementary functional groups react to create interpenetrating networks thereby increasing melt viscosity of the combined fiber mass and reducing the dripping characteristics of the fabric.

In another embodiment, one of the fibers containing complimentary functional groups is spiral wound on top of another fiber containing a complementary functional group capable of reacting with the first fiber. Thus when exposed to flame, both fibers fuse together generating interfacial crosslinks capable of reducing melt viscosity.

In another embodiment, two fibers are the same material with different functional groups. For example, a nylon fiber which has an additive such as a multiamine polymer can be co-woven with another passivated nylon fiber containing a polyepoxy compound or a polyanhydride compound.

In another embodiment, the woven fibers could be in the same direction (warp) or in orthogonal direction (weft). This enables the fibers to fuse along their length (warp) or at junction points when they are woven orthogonal to each other (weft).

In another embodiment, a third neutral fiber that does not melt (such as cotton or rayon) can be added as a minority component of the fabric during weaving process. The third fiber can act as scaffolding around which functionalized fibers can melt and form a high viscosity front against a flame front. The third fiber has a higher melting temperature than either the first or second fibers. Other examples of this third resin or polymer include thermoplastic polyetherimide (PEI) resins (e.g., ULTEM manufactured by SABIC), polyetheretherketone (PEEK), wool, hair, silk, or aramid (such KEVLAR or NOMEX).

In another embodiment, metallic fibers are interwoven to act as heat sinks such that heat from the flame area can be carried to a distant location where melt fusing of the functional fibers could occur, thus preventing further propagation of the flame front. These metallic fibers may be copper, ferrous materials (such as steel wool), gold, silver, nickel, manganese, aluminum, or other metals or alloys that can act as heat sinks.

In another embodiment, the multi-functional additives could themselves contain flame retardant entities such as phosphates or phosphonates (e.g., an epoxy-containing phosphorus compound) which help form char on the surface exposed to flame, thus helping self-extinguish burning articles.

In another embodiment, the two complimentary fibers or three complementary fiber/inert fiber combination (two complimentary fibers along with one or more inert fibers) can be converted into fabric using weaving techniques or knitting techniques. In an example, the three fiber combination fabric is made by using functionalized-polyester, functionalized-nylon, and a metallic fiber or functionalized-polyester, functionalized-nylon, and a polypropylene fiber.

Complimentary fibers are those that have reactive groups which can react to link the fibers. Inert fibers are substantially devoid of such reactive groups.

In another embodiment, a nitrogen-containing synergist such as melamine can be melt blended in one fiber and a molecule containing epoxy groups in the other fiber made of passivated nylon for example. This nitrogen-containing synergist is an additive in a fiber that contains nitrogen. When these two fibers melt and fuse in the presence of a flame, a reaction is initiated between melamine and epoxy thereby creating a cross-linked network that behaves like a thermoset. As the melting temperature of melamine is 350° C., no reaction is expected to occur with melamine during the traditional processing temperatures used for producing nylon or PET fibers (e.g., <300° C.). This network should reduce melt dripping and help self-extinguish the flame. In another embodiment the melamine additive could be used in conjunction with an additive containing phosphorus, as the nitrogen containing molecules synergistically aid the flame retardant properties of phosphorus containing molecules. The cross-linked network is a large molecular weight polymer with low melt viscosity. The additional bonds between chains formed during crosslinking have to be broken before stepwise degradation of chain occurs during pyrolysis. Crosslinking also increases melt viscosity of the molten polymer in the combustion zone, thereby lowering the rate of transport of the combustible pyrolysis products (e.g., flammable gases) to the flame. While melamine is discussed, urea, guanidine carbonate, melamine cyanurate, melamine formaldehyde, melamine phosphate, melamine polyphosphate, or other materials also may be used.

In another embodiment, crosslinking can be brought about between merging melt fronts such as those encountered in bicomponent fibers. These fibers are made by mixing two dissimilar materials in the spinneret head to create fibers with two different materials joined together in different shapes. Both fibers are functionalized with functional groups that are complementary. This technique can be exploited to create cross-linked fibers. In one example, two streams of PET polymer melts, one containing a nylon resin sold under the trade name ELVAMIDE (manufactured by DuPont) and the other containing a bifunctional crosslinker such as diglycidyl ether of polyethylene glycol (PEG) are brought together. The PET molecules may or may not be rendered passive by pre-reacting with a monofunctional hydroxyl containing molecule or an epoxy containing molecule. When the melt fronts meet, the reactive molecules react with one another forming crosslinks where the melt fronts meet resulting in enhanced resistance to melt dripping in the case of a fire. The bicomponent fibers could also be made of two different melt streams. For example one may be nylon and the other may be passivated PET. The PET part can contain a polyanhydride or a bifunctional crosslinker such as diglycidyl ether of PEG while the nylon part can contain no additives or low molecular weight nylon analogues such as hexamethylenetetramine (HMTA), triethylenetetramine (TETA), tetraethylenepentamine (TEPA), or pentaethylenehexamine (PEHA). When the PET and nylon melts are brought together, the crosslinking occurs between the amines and the anhydrides (or the epoxy) creating an interpenetrating network that inhibits melt dripping.

Weaving or knitting techniques capable of producing the fabric with improved melt dripping properties can be used. For example, the compositions disclosed herein can be formed into fibers and woven to make fabrics.

The invention also concerns compositions, articles (e.g., fibers or fabrics), and methods related to benign and non-toxic flame retardants in which the flame retardant molecules or particles are anchored to a polymer matrix of an article or finished product, and are stably and uniformly distributed therein. In an aspect, phosphorus containing chemicals are effective flame retardants and are used to replace brominated compounds due to the environmental concerns associated with the brominated compounds.

The compositions may include one or more phosphorous based flame retardant molecules reacted with one or more anchors, such as, oligomeric or polymeric chains having a reactive functional group, such as an epoxy functional group, a hydroxyl functional group, an anhydride functional group, a carboxyl functional group, a sulfhydryl functional group, an ester functional group, an ether functional group, and other functional groups of the type, or combinations thereof, contained therein, forming a modified flame retardant or conjugate. The modified flame retardant may be incorporated into a polymer matrix, via bonding or physical entanglement, and used to impart flame retardant properties to a final product, such as paints, textiles, coatings, and other articles.

In another embodiment, the crosslinking and network formation can be initiated by the use of molecules that react at very high temperatures, such as those encountered in flames.

In an embodiment, compounds containing N═N such as azo compounds can be reacted with functional ends of polymers such as nylon and PET, which contain reactive functional groups such as amines, carboxyls, hydroxyls, or other functional groups. Such compounds are examples of reactive components. Such end modified polymers can then be converted into articles such as fibers and moldings using conventional processing techniques. When such articles are exposed to flames, a thermally initiated radical reaction occurs between neighboring azo functional groups creating a network of crosslinked polymers.

In an example, an azo molecule with a monofunctional reactive group reacts with a polymer end group. The modified polymer may or may not become passivated through the reaction. When such polymers are exposed to flame and/or heat, the azo function group homopolymerizes to increase the crosslinking of the original polymer thereby increasing the melt polymer viscosity of the and reducing the polymer dripping characteristics. An example molecule, methyl red, has a carboxylic acid group that can be react with the terminating amine group of nylon. The azo functionalized nylon may further polymerize when exposed to heat/flame through the azo reactivity at elevated temperatures above processing.

In another embodiment, an azo molecule with multiple reactive groups reacts with multiple polymer end groups. The polymer chains are connected via crosslinking. In one example, the amine groups of Bismarck Brown Y can be reacted with the carboxylic acid terminated end group of nylon or PET. The reacted Bismarck Brown Y may crosslink multiple polymer chains together increasing the molecular weight and viscosity of the nylon. The azo functionalized nylon may further polymerize when exposed to heat/flame through the azo reactivity to radicals formed at elevated temperatures above processing.

In another embodiment, an azo molecule with multiple numbers and identities of functional groups may react with single or multiple polymer end groups. When multiple polymer end groups are reacted, the polymer chain may connect via crosslinking. In one example, the amine groups of Trypan Blue can be reacted with the carboxylic acid terminated end group of nylon or PET, or the acid groups of Trypan Blue can be reacted with the amine terminated end group of nylon. The reacted Trypan Blue may crosslink multiple polymer chains together increasing the molecular weight and viscosity of the nylon. The azo functionalized nylon may further polymerize when exposed to heat/flame through the azo reactivity to radicals formed at elevated temperatures above processing.

The invention is by the following experimental examples which are not intended to be limiting in nature.

### Experimental Example 1

To 452.6 g of nylon 6, molecular weight of 40,000, 1.2 g of benzoic anhydride was dry mixed for high dispersion of the powdered solids. The dry mix was fed into a twin-screw extruder and melt processed between 230-260° C. The extruded strands were cooled and pelletized.

### Experimental Example 2

To 452.6 g of nylon 6, molecular weight of 40,000, 1.2 g of succinic anhydride was dry mixed for high dispersion of the powdered solids. The dry mix was fed into a twin-screw extruder and melt processed between 230-260° C. The extruded strands were cooled and pelletized.

### Experimental Example 3

To 452.6 g of nylon 6, molecular weight of 40,000, 1.2 g of maleic-anhydride was dry mixed for high dispersion of the powdered solids. The dry mix was fed into a twin-screw extruder and melt processed between 230-260° C. The extruded strands were cooled and pelletized.

### Experimental Example 4

To ascertain the passivation of nylon 6 by the benzoic anhydride, the pellets made in Example 1 were mixed with 2% 1,4-butanediol diglycidyl ether (ERISYS GE 21 from CVC Chemicals). The dry mix was fed into a twin-screw extruder and melt processed between 230-260° C. The extruded strands were cooled and pelletized. A control sample was prepared by mixing nylon 6 which was not modified by any means with 2% 1,4-butanediol diglycidyl ether. The dry mix was fed into a twin-screw extruder and melt processed between 230-260° C. The extruded strands were cooled and pelletized.

The melt flow of the pellets was measured using a Zwick melt flow index tester. The control nylon with a melt flow of 20 g/min was found to have a melt flow of 0.7 g/min after reaction with 2% 1,4-butanediol diglycidyl ether. While the passivated nylon was found to have a melt flow of 20 g/min before and after mixing and extruding with 2% 1,4-butanediol diglycidyl ether. This indicated that the passivation step did not affect the molecular weight of nylon 6 but only rendered it inert to reaction with 2% 1,4-butanediol diglycidyl ether. Whereas the control nylon6 was crosslinked when extruded with 2% 1,4-butanediol diglycidyl ether resulting in a non-flowable polymer.

### Experimental Example 5

To 452.6 g of nylon 6, molecular weight of 40,000, 1.4 g of Bismarck Brown Y, 50% dye content, (0.3 wt % or 0.004 mol) was dry mixed for high dispersion of the powdered solids. The dry mix was fed into a twin-screw extruder and melt processed between 230-260° C. The extruded strands were cooled and pelletized.

### Experimental Example 6

To 451.3 g of nylon 6, molecular weight of 40,000, 2.7 g of methyl red, (0.8 wt % or 0.1 mol) was dry mixed for high dispersion of the powdered solids. The dry mix was fed into a twin-screw extruder and melt processed between 230-260° C. The extruded strands were cooled and pelletized.

Although the compositions, articles, and methods have been described and illustrated in connection with certain embodiments, many variations and modifications will be evident to those skilled in the art and may be made without departing from the spirit and scope of the disclosure. The discourse is thus not to be limited to the precise details of methodology or construction set forth above as such variations and modification are intended to be included within the scope of the disclosure.

1. A composition comprising:
a plurality of first resins that include a first polymer; and
a reactive component, wherein the reactive component is present at 0.1% to 10% by weight of the polymer, wherein the first polymer or the first polymer and the reactive component are configured to crosslink upon exposure to flame, wherein the first polymer or the first polymer and the reactive component are configured to not react at a melting temperature of the first polymer, wherein the reactive component is a crosslinking molecule, wherein the first polymer is rendered inert to reaction with crosslinking molecules until the exposure to flame, and wherein the first polymer is configured to split into fragments with reactive ends upon the exposure to flame such that the reactive ends react with the reactive component to form a network interpenetrating polymer that enhances molecular weight and viscosity.

2. The composition of claim 1, wherein the first polymers include at least one reactive end group, wherein the reactive end group is selected from the group consisting of an amine, a carboxyl, and a hydroxyl.

3. The composition of claim 1, wherein the first polymer is one of nylon or polyethylene terephthalate (PET).

4. The composition of claim 3, wherein the first polymer is nylon, and wherein the reactive component includes a functional group selected from the group consisting of an epoxy, an anhydride, an amine, an isocyanate, and a hydroxyl.

5. The composition of claim 1, wherein chain ends of the first polymer are modified by the reactive component, wherein the chain ends are configured to react with each other upon exposure to a temperature above the melting temperature of the first polymer.

6. The composition of claim 1, wherein the first polymer includes at least one functional group, and wherein the functional group is blocked or passivated such that the first polymer is rendered inert to reaction with crosslinking molecules until exposure to a temperature above the melting temperature of the first polymer.

7. The composition of claim 6, wherein the reactive component is a monofunctional molecule having functional groups complementary to end groups of the first polymer.

8. The composition of claim 7, wherein a reaction between the reactive component and the first polymer forms a covalent linkage.

9. (canceled)

10. The composition of claim 1, wherein the crosslinking is configured to provide chain scission.

11. The composition of claim 10, wherein the chain scission creates fragments with reactive end groups, and wherein the reactive end groups are selected from the group consisting of caprolactone and caprolactam.

12. The composition of claim 10, wherein the chain scission creates fragments with reactive end groups, and wherein the reactive end groups are selected from the group consisting of amine and carboxyl.

13. (canceled)

14. The composition of claim 1, wherein the reactive component includes a nitrogen double bond, wherein the reactive component is an azo compound, and wherein the reactive component is configured to homopolymerize upon the exposure to flame thereby increasing crosslinking of the first polymer.

15. (canceled)

16. (canceled)

17. The composition of claim 14, wherein the reactive component is configured to react with multiple end groups of the first polymer upon the exposure to flame.

18. (canceled)

19. The composition of claim 1, wherein the reactive component and the first polymer are configured to not react upon the exposure to flame, and wherein the first polymer is configured to only crosslink with itself upon the exposure to flame thereby forming a network interpenetrating polymer that enhances molecular weight and viscosity.

20. A fabric formed from the composition of claim 1.

21. (canceled)

22. (canceled)

23. (canceled)

24. A method comprising:
providing a plurality of first resins that include a first polymer;
providing a reactive component, wherein the reactive component is present at 0.1% to 10% by weight of the polymer; and
mixing the first polymer and the reactive component to form a composition, wherein the first polymer or the first polymer and the reactive component are configured to crosslink upon exposure to flame, wherein the first polymer or the first polymer and the reactive component are configured to not react at a melting temperature of the first polymer, wherein the reactive component is a crosslinker, wherein the first polymer is rendered inert to reaction with crosslinking molecules until the exposure to flame, and wherein the reactive component is an interstitial additive.

25. (canceled)

26. The method of claim 24, further comprising forming fibers from the composition and weaving the fibers to form a fabric.

27. (canceled)

28. The method of claim 24, further comprising passivating the first polymer prior to exposure to the reactive component.

29. The method of claim 28, wherein the mixing occurs during extrusion after passivating.

30. A method comprising:
providing a composition that includes a plurality of first resins that include a first polymer and a reactive component, wherein the reactive component is present at 0.1% to 10% by weight of the polymer;
exposing the composition to flame, wherein the reactive component and the first polymer are configured to not react upon the exposure to flame, and wherein the first polymer is configured to only crosslink with itself upon the exposure to flame; and
forming a network interpenetrating polymer that enhances molecular weight and viscosity thereby reducing melt dripping.
